(19) United States
(12) Patent Application Publication
(10) Pub. No.: US 2017/0293420 A1
(43) Pub. Date: Oct. 12, 2017

(54) METHOD FOR INPUTTING TEXT BY TOUCH PAD

(71) Applicant: Seokgyun BAE, Incheon (KR)

(72) Inventor: Seokgyun BAE, Incheon (KR)

(21) Appl. No.: 15/036,062

(22) PCT Filed: Nov. 6, 2014
(86) PCT No.: PCT/KR2014/010600

§ 371 Date: Jun. 28, 2016

(30) Foreign Application Priority Data
Nov. 11, 2013 (KR) 10-2013-0135964

(51) Int. Cl. G06F 3/0488; G06F 3/023

(52) U.S. Cl. CPC G06F 3/04883; G06F 3/04886; G06F 3/0233

(57) ABSTRACT

The purpose of the present invention is enable Korean text and other text to be more conveniently inputted into devices using a touch pad of a smart phone or the like. The present invention enables the next letter arranged on the same button to be immediately selected without a shift key or a separate function corresponding thereto. The present invention enables the next arranged letter to be selected when any part of a screen is touched while a corresponding letter is pressed, instead of the conventional way of continuously pressing a shift key or the same button within a wait time for inputting a letter also arranged on the same button. Through the present invention, the need for users to change the keyboard is reduced when inputting letters, the number of buttons to be inputted is reduced when one word or one sentence is completed in comparison with conventional input methods, and a wait time is reduced such that it is possible to more conveniently and quickly complete a desired word and a desired sentence.

### TECHNICAL FIELD

The present invention relates to a method for inputting a text using a touch pad, and more particularly, to a method which may reduce a wait time for inputting letters such that when one button, that is, a letter is selected in a device which uses a method of inputting a text using a smart phone or a touch pad, if a surrounding of the button is touched by a finger while pressing the button with another finger without detaching the finger, a next letter which is assigned to the same key is input like a shift function of a computer keyboard .

In the case of a text input method using a touch pad of the related art, for example, when English alphabets A, B, and C or Korean alphabets “ [symbol] and [symbol] ” are assigned to one button, in order to input an English alphabet B after inputting an English alphabet “A” or input a Korean alphabet “ [symbol] ” immediately after inputting a Korean alphabet “ [symbol] ”, it is inconvenient because the button needs to be used after waiting for a predetermined time. Further, in order to input the English alphabet B or the Korean alphabet “ [symbol] ”, it is inconvenient because the button needs to be quickly pressed before the wait time has elapsed. However, according to the present invention, the wait time is not considered to input the letter, so that the inconvenience thereby may be solved.

Further, in the case of a key to which the English alphabets “A and a” are assigned, in order to select a next key other than a default setting, it is inconvenient because “Shift+A” needs to be pressed. However, according to the method of the present invention, it is possible to simply input the letters without using a “Shift” key.

### BACKGROUND ART

This invention claims the priority of Korean Patent Application No. 10-2013-0135964 in the Korean Intellectual Property Office.

### DISCLOSURE

### Technical Problem

Generally, when a letter is input using a touch pad, it is inconvenient because the button needs to be pressed within a wait time in order to input a second or third letter of the selected key or the wait time needs to elapse to continuously use the button.

Further, when many letters are assigned to one button, the wait time is so long or the button may be pressed so many times. Therefore, a shift function of the computer keyboard or a corresponding keyboard (a Korean keyboard, an English keyboard, or a special character keyboard) needs to be changed. This may be a major cause of difficulty of usage or a typographical error when a letter is input.

Therefore, the present invention has been made in effort to solve the above problems such that when any place of surroundings of a selected button is pressed while pressing the selected button, a next letter which is assigned to the button is selected, to solve various problems caused by the wait time and reduce a unnecessary time to select the keyboard (the Korean keyboard, the English keyboard, or the special character keyboard).

### Technical Solution

According to the present invention, when a button is selected to input a letter onto a touch pad and a second assigned letter rather than a first assigned letter is input or an English alphabet or a special character is input from a Korean keyboard, any place of a screen of the surrounding is selected to select a next letter assigned to the button.

According to the button input method, a user does not need to have a wait time to input a letter and inconvenience or a time to change a keyboard to simply input one letter is not necessary, thereby conveniently and quickly using a letter.

### Advantageous Effects

As described above, a user who inputs letters using a touch pad by a text input method of the present invention does not need to wait for a wait time in order to continuously use the same letter. Further, the user may not experience inconvenience to quickly press the button within the wait time to input a next letter corresponding to one button or delete the previously input letter and then reselect a letter when the wait time is over.

Further, when the letter is input using a Korean keyboard, there is no need to inconveniently change the keyboard several times to select one special character, an upper case alphabet, a lower case alphabet, or the like. Therefore, the text input method of the present invention is very useful and effective to significantly reduce the inconvenience of the user and a time to input a letter.

According to the present invention, when a value such as “A or a” assigned to one key is input, the letter is input in accordance with the number of times of touching any place while pressing the corresponding key without changing a shift key or a keyboard. Therefore, in a keyboard related application or a software of the device which is previously used for a smart phone or a touch pad, a programming for processing parts related with a new input type is added to simply upgrade the application or the software.

### MODES OF THE INVENTION

Hereinafter, exemplary embodiments of the present invention will be described below.

Further, the exemplary embodiments do not limit the scope of the present invention, but are suggested for illustrative purpose and various modifications are possible without departing from the technical gist thereof.

Two settings are required to implement a function according to the present invention.

A first setting is that a letter corresponding to a selected key is selected like a shift button of a computer keyboard while pressing the button, instead of pressing the button and then releasing the button.

A second setting is that when any place of a screen of surroundings of the button is additionally touched while pressing the button, an order of letters corresponding to the pressed button is selected in accordance with the number of times of touching the screen.

In the case of a touch pad keyboard, corresponding letters “ [symbol] , [symbol] , R” are assigned to a keyboard “ [symbol] ”.

Therefore, on a Korean keyboard of the touch pad, when the button is pressed once, “ [symbol] ” is selected. When the button is pressed again within a wait time, “ [symbol] ” is displayed. In order to input “R”, the keyboard needs to be changed into an English keyboard and then select an upper case or a lower case again.

However, in the present invention, when a vowel and a consonant are basically assigned to each button, a fortis is assigned as a next corresponding letter, an upper case alphabet is assigned as a third letter, and a lower case alphabet is assigned as a fourth letter, the user may input all letters as it is without changing a setting or waiting for a wait time.

For example, when the user wants to input “ [symbol] ”, if the user touches any place of the surroundings of the button while pressing the “ [symbol] ” button, the second assigned letter “ [symbol] ” is selected. When the user touches the screen two times, an upper case alphabet “R” which is the third assigned letter is selected. Further, when the user touches the screen three times, a lower case alphabet “r” which is the fourth assigned letter is selected.

In this case, when the special character is set as a fifth assigned letter or assigned to “o” which does not have a corresponding fortis, the special character is also conveniently used.

Further, when the user can add or select a type of arrangement assigned to each button, not only the Korean keyboard and the English keyboard, but also a Japanese keyboard and a Chinese keyboard may be used at once. Further, when frequently used special characters can be additionally changed, the inconvenience of the related art may be solved, convenience of the usage may be increased and a time to input letters may be shortened.

### INDUSTRIAL APPLICABILITY

According to the present invention, a key may be conveniently and quickly input only by adding a function of the present invention to a keyboard input software or application (App) which is used in a smart phone or a touch pad of the related art, without creating a new form. Further, since a function of a shift key is not necessary, a key which is not utilized is used as a function key having a function corresponding to a start key of Windows. Therefore, the key may be conveniently input and a time to input the key may be shortened. Further, various availabilities and possibilities may be provided.

1. A method for inputting a text using a touch pad, wherein a next letter which is assigned to a selected button is selected by touching any place of a screen of surroundings while pressing the selected button.

2. The method according to claim 1, wherein a second row or a third row of a character string corresponding to each button is set to correspond to upper case alphabets or lower case alphabets, so that the letter is input without selecting Korean-English conversion or upper case-lower case conversion.
